(19) United States
(12) Patent Application Publication
(10) Pub. No.: US 2011/0316332 A1
(43) Pub. Date: Dec. 29, 2011

(54) Transport vehicle with a plurality of electrical machines

(75) Inventors: Thorsten Karnatz, Berlin (DE); Lutz Steinhaus, Berlin (DE)

(73) Assignee: Converteam GmbH, Berlin (DE)

(21) Appl. No.: 13/067,767

(22) Filed: Jun. 24, 2011

(30) Foreign Application Priority Data
Jun. 28, 2010 (DE) 10 2010 025 266.2

(51) Int. Cl. B60L 1/00; H02B 1/30

(52) U.S. Cl. 307/9.1; 361/622

(57) ABSTRACT

Described is a transport vehicle provided with a plurality of electrical machines and power converters which serve to connect the electrical machines to a DC intermediate circuit. Also provided is a separate power converter for feeding electrical energy into the DC intermediate circuit. All power converters are respectively configured with an identical power electronic module which includes controllable power semiconductor switches, wherein different functions can be achieved through differently activating the power semiconductor switches.

### PRIORITY STATEMENT

The present application hereby claims priority under 35 U.S.C. §119 on German patent application number DE 10 2010 025 266.2 filed Jun. 28, 2010, the entire contents of which are hereby incorporated herein by reference.

### FIELD

At least one embodiment of the present invention generally relates to a transport vehicle provided with a plurality of electrical machines, with power converters for connecting the electrical machines to a direct current (DC) intermediate circuit, as well as with a different power converter for feeding electrical energy into the DC intermediate circuit. At least one embodiment of the present invention furthermore generally relates to a switch cabinet for a transport vehicle of this type, as well as to an associated power converter.

### BACKGROUND

A transport vehicle is known from the document DE 10 2004 028 353 A1 which describes an energy management system for a transport vehicle, in particular for a fuel-electric vehicle provided with an energy source, an intermediate energy storage device and an electrical consumer, in particular an electrical drive. A diesel motor used for driving generators is disclosed therein as the energy source.

### SUMMARY

In at least one embodiment, an improvement to this known transport vehicle is disclosed.

At least one embodiment is directed to a transport vehicle as, and at least one embodiment is directed to a switch cabinet. At least one embodiment is also directed to a power converter.

All power converters according to at least one embodiment of the invention are configured with a respectively identical, power electronic module which comprises controllable power semiconductor switches, wherein different modes of operation can be achieved for the power electronic module by differently controlling the individual power semiconductor switches.

The power electronic module can thus be activated in different ways, so as to realize different modes of operation. As a result, the module can be produced in larger piece numbers to reduce the production expenditure and the costs. The assembly and any possibly required repairs of the power-electronic module are furthermore simplified in this way.

It should advantageously be possible to operate the power-electronic module either as a rectifier, or as a DC/AC converter, or as an ON/OFF switch, wherein it should also be possible to change these different module functions during the operation.

It is particularly advantageous if the power-electronic module is embodied as a plug-in module and if the transport vehicle is provided with a switch cabinet comprising slots for plugging in power-electronic modules. The assembly of the power-electronic module is further simplified in this way.

### BRIEF DESCRIPTION OF THE DRAWINGS

Additional features, options for use and advantages of at least one embodiment of the invention follow from the description below of example embodiments of the invention which are shown in the drawings. All described and shown features, either by themselves or in any optional combination represent the subject matter of at least one embodiment of the invention, regardless of how they are combined in the patent claims and regardless of the references back, as well as independent of the their formulation and/or the representation in the specification or the drawings, showing in:

FIG. 1: A schematic block diagram of an example embodiment of a transport vehicle according to the invention;

FIG. 2: A schematic circuit diagram of parts of the transport vehicle shown in FIG. 1; and

FIG. 3: A circuit diagram of a power electronic module used in the transport vehicle according to FIG. 1.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

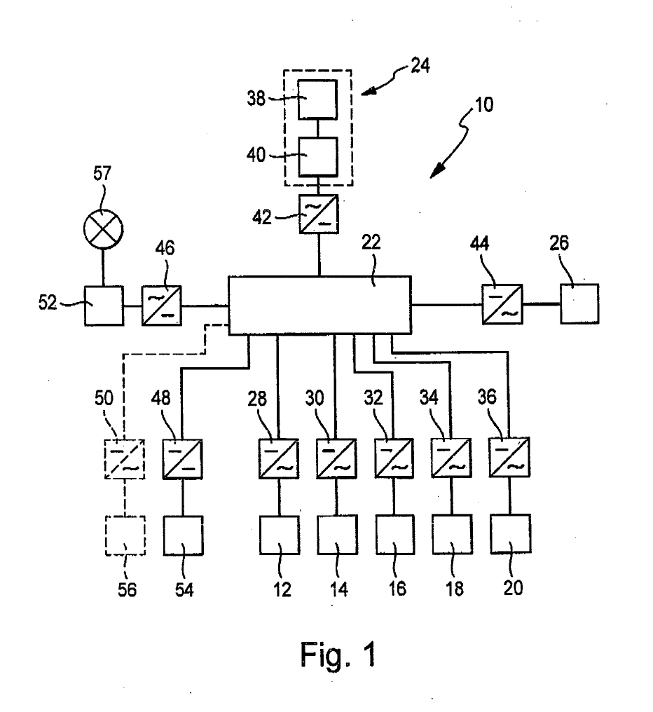

FIG. 1 represents a detailed view of a transport vehicle 10 with a plurality of electrical machines 12, 14, 16, 18, 20, a DC intermediate circuit 22 and a first feeding device 24 and/or a second feeding device 26.

For the embodiment shown herein, the transport vehicle 10 is a mobile crane, for example used in a port, a rubber-tire stacking crane, or a mobile construction site crane with a diesel-electric hybrid drive. It is understood that an embodiment of the invention can also be realized with a locally fixed crane, such as a locally fixed crane at a construction site, or an overhead crane.

The electrical machines 12, 14, 16, 18, 20 are connected via power converters 28, 30, 32, 34, 36 to the DC intermediate circuit 22. The electrical machine 12 is used to drive a lifting device while the electrical machines 14, 16, 18, 20 are used to drive chassis engines. This type of embodiment is used, for example, with a rubber-tire stacking crane with four wheels where each wheel is driven by one of the electric machines. It is understood that an embodiment of the invention is not limited to an embodiment of this type.

The first energy feeding device 24 is realized as a fuel-electric drive and is provided with a combustion engine 38 as well as an electrical machine 40 which can be operated either as electric motor or as generator. The first energy feeding device 24 is connected via a first power converter 42 to the DC intermediate circuit 22.

A power converter in this case is understood to refer to any type of electrical device which is suitable for converting a first type of current to a second type of current. For example, if a power converter is intended for converting an alternating current to direct current, it is a rectifier and vice versa it is called a DC/AC converter or inverter.

Alternatively or in addition to the first feeding device 24, the second feeding device 26 is connected via a second power converter 44 to the DC intermediate circuit 22. The second energy feeding device 26 is embodied so as to connect the transport vehicle 10 with an external power grid.

An auxiliary power supply 52 for the transport vehicle 10, as well as one or several energy storage devices 54, 56 for the transport vehicle 10, are connected to the DC intermediate circuit 22 via additional power converters 46, 48 and/or 50.

The auxiliary power supply 52 functions to operate auxiliary electric devices in the transport vehicle 10, for example its lighting system 57. For the example embodiment shown herein, the energy storage device 54 is a direct current storage device such as a rechargeable storage battery and/or a condenser arrangement. Alternatively or in addition to the DC storage device 54, other embodiments are provided with an AC storage device 56. For example, the AC storage device 56 can be realized in the form of an armature for an electrical machine which rotates with a high inertial moment.

According to one example embodiment, the electrical machines 12, 14, 16, 18, 20, 40, 56 can be operated either as electric motors or as generators. The power converters 28, 30, 32, 34, 36, 42, 44, 46, 48, 50 are preferably converters which are capable of energy feed-back. This type of embodiment permits an energy exchange via the DC intermediate circuit 22. For example, if a load is reduced, the associated electrical machine 12 can be operated as a generator and the electrical current generated by this machine can be used for driving the electrical machines 14, 16, 18, 20, which are simultaneously operated as drive motors, or for charging the energy storage device 54 and/or 56.

As a result, the momentarily required electrical power does not have to be generated, or at least not completely, by the generator 40. The generator 40 as well as the driving combustion engine 38 consequently can have smaller dimensions. In addition, load peaks occurring in one or several electrical machines 12, 14, 16, 18, 20 can be totally or partially compensated for with power contributed by the electrical energy storage device 54 and/or 56 or by electrical energy simultaneously fed back by other electrical machines.

Soot clouds vented during the sudden load increase for a diesel engine in the form of a combustion engine 38 driving the generator 40 can thus be avoided.

Once example embodiment furthermore provides that the generator 40 can be operated as electric starter for the combustion engine 38, thus making it possible to omit the normally required separate electric starter.

The transport vehicle 10 comprises a switch cabinet with slots for the power converters 28, 30, 32, 34, 36, 42, 44, 46, 48, 50, 58 which are preferably realized as plug-in converters. The power converters in that case can simply be plugged into these locations in the switch cabinet. An easy to view and compact arrangement of the power converters 28, 30, 32, 34, 36, 42, 44, 46, 48, 50, 58 is thus ensured, which facilitates the installation and, if applicable, the replacement of these converters. In addition, the DC intermediate circuit 22 can also be housed inside the switch cabinet.

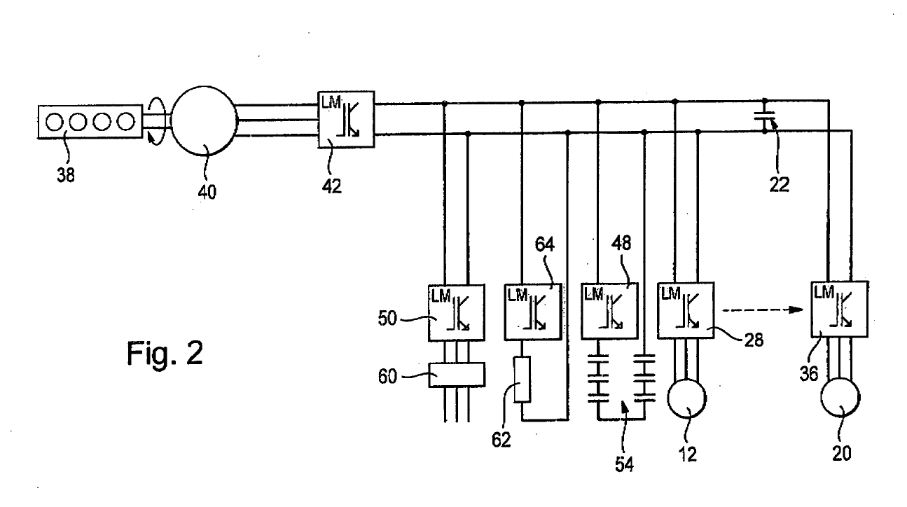

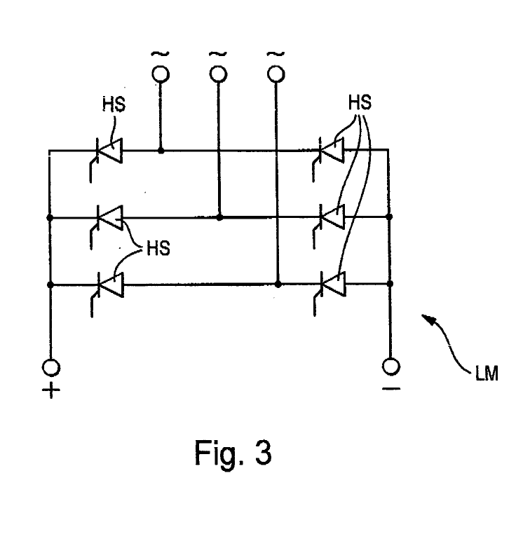

FIG. 2 shows the combustion engine 38 and the electrical machine 40 which are connected via a rotating shaft. The machine 40 is connected to the power converter 42 which, in turn, is connected to the DC intermediate circuit 22, wherein the machine 40 can be operated as a generator as well as a motor. The power converter 42 is shown as high-power electronic module LM and will be explained further with the aid of FIG. 3. The DC intermediate circuit 22 is shown in FIG. 2 in the form of a capacitor.

The electrical machines 12, 14, 16, 18, 20 are connected via the power converters 28, 30, 32, 34, 36 to the DC intermediate circuit 22, wherein the latter power converters are again shown in the form of high-power electronic modules LM.

The power converter 48 with the energy storage device 54 is connected to the DC intermediate circuit 22. The energy storage device 54 in this case is shown as a series connection of several capacitors. Furthermore connected to the DC intermediate circuit 22 is the power converter 50 which is connected via a filter 60 or the like to the energy storage device 56, in a manner not shown herein. The last-mentioned power converters 48, 50 are again shown as high-power electronic modules LM.

Finally, a resistance 62 is connected for the example embodiment via a converter 64 to the DC intermediate circuit 22. The resistance 62 can be used as braking resistance and/or brake chopper, wherein the power converter 64 is again shown as high-power electronic module LM.

All power converters 28, 30, 32, 34, 36, 42, 44, 46, 48, 50, 64 are respectively configured with identical high-power electronic modules LM. This module LM is used within the transport vehicle 10 for different functions, but nevertheless always has the same switching-technical design. The different functions of the power-electronic module LM are achieved through different activations of this module.

FIG. 3 shows the power-electronic module LM which can be, for example, a fully controlled six-pulse bridge circuit. For this, three series connections including respectively two electronic semiconductor switches HS are switched parallel to each other. For the present embodiment, the connecting points between the two semiconductor switches HS of the respective series connections represent a three-phase AC tap, while the respectively outer points of the three series connections represent the two poles of a DC tap.

The power semiconductor switches HS are controllable and can be embodied, for example, as thyristor or IGBT (IGBT=insulated gate bipolar transistor) or the like. A control unit, which is not shown and can be embodied as a microprocessor or personal computer, is provided for activating the power semiconductor switches HS.

The power electronic module LM is embodied as plug-in module and can thus be plugged into the aforementioned slots in the switch cabinet of the transport vehicle 10. The control unit can furthermore also be housed inside the switch cabinet.

It is understood that the power electronic module LM can also be embodied differently, wherein half bridges or freewheeling diodes or the like can also be provided.

The power electronic module LM is suitable to conduct electrical energy from the AC tap to the DC tap and vice versa. With respect to the energy flow, the power electronic module LM can be operated in both directions, meaning the power electronic module LM can be operated as a rectifier and as a DC/AC converter.

This varying mode of operation of the power electronic module LM is achieved in that the control unit correspondingly activates the power semiconductor switches HS. The control unit thus makes it possible to change the mode of operation of the power electronic module LM during the operation of the transport vehicle, for example to change the direction of the energy flow.

In the case of the power converter 42, the power electronic module LM is normally operated as rectifier while in the case of the power converters 28, 30, 32, 34, 36, 50, the power electronic module is normally operated as DC/AC converter.

The power electronic module LM is furthermore suitable for use as a switching device only which is the case, for example, with the converters 48, 64. The power semiconductor switches HS in that case are controlled by the control unit in such a way that the complete module LM functions as an ON/OFF switch between the two poles of the DC tap, meaning is causes either a short circuit or an interruption. The AC tap of the power electronic module LM is not used in that case.

It is understood that the above-described device can be used not only with a transport vehicle, but also with other technical apparatuses using a plurality of electrical machines. If applicable, it is sufficient in that case to transfer and use the switch cabinet which is described for the transport vehicle 10 and contains the power converters and, if applicable, also the DC intermediate circuit and the control unit to the other technical device.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A transport vehicle, comprising:
a plurality of electrical machines;
power converters, to operatively connect the plurality of electrical machines to a DC intermediate circuit, each of the power converters including an identical power electronic module which comprises controllable power semiconductor switches, with different modes of operation of the power electronic module being achievable through different activation of the power semiconductor switches; and
a converter to feed electrical energy into the DC intermediate circuit.

2. A switch cabinet, comprising:
power converters to connect a plurality of electrical machines to a DC intermediate circuit; and
a power converter to feed electrical power to the DC intermediate circuit, the power converters being respectively configured with an identical power-electronic module which comprises controllable power semiconductor switches, with different modes of operation of the power electronic module being achievable through different activations of the power semiconductor switch.

3. The transport vehicle according to claim 1, wherein the power electronic module is operatable as a DC converter.

4. The transport vehicle according to claim 1, wherein the power electronic module is operatable as a DC/AC converter.

5. The transport vehicle according to claim 1, wherein the power electronic module is operatable as an ON/OFF switch.

6. The transport vehicle according to claim 1, wherein the power semiconductor switches are embodied as IGBT (IGBT=insulated gate bipolar transistor) switches.

7. The transport vehicle according to claim 1, wherein the power electronic module is embodied as plug-in module.

8. The transport vehicle according to claim 1, wherein the transport vehicle is a crane.

9. A power converter for the transport vehicle according to claim 1.

10. The transport vehicle according to claim 8, wherein the crane is at least one of a crane used in a port, a stacking crane, an overhead crane used inside a hangar, and a crane used on a construction site.

11. The switch cabinet according to claim 2, wherein the switch cabinet is for a transport vehicle, and wherein the transport vehicle includes the plurality of electrical machines.

12. The switch cabinet according to claim 2, wherein the power electronic module is operatable as a DC converter.

13. The switch cabinet according to claim 2, wherein the power electronic module is operatable as a DC/AC converter.

14. The switch cabinet according to claim 2, wherein the power electronic module is operatable as an ON/OFF switch.

15. The switch cabinet according to claim 2, wherein the power semiconductor switches are embodied as IGBT (IGBT=insulated gate bipolar transistor) switches.

16. The switch cabinet according to claim 2, wherein the power electronic module is embodied as plug-in module, and wherein the switch cabinet contains slots for plugging in the power electronic modules.

17. A power converter for the switch cabinet according to claim 2.

18. The power converter according to claim 17, wherein the power electronic module is embodied as fully controlled six-pulse bridge circuit.
